(19) United States
(12) Patent Application Publication
(10) Pub. No.: US 2004/0088068 A1
(43) Pub. Date: May 6, 2004

(54) Method and apparatus for providing first-principles feed-forward manufacturing control

(76) Inventor: Daniel Kadosh, Austin, TX (US)

Correspondence Address: Scott F. Diring, Williams, Morgan & Amerson, P.C., Suite 250, 7676 Hillmont, Houston, TX, 77040, US

(21) Appl. No.: 10/284,969

(22) Filed: Oct. 31, 2002

(51) Int. Cl. G06F 19/00

(52) U.S. Cl. 700/108

(57) ABSTRACT

A method includes processing a workpiece in a manufacturing system including a plurality of tools. Workpiece fabrication data related to the processing is retrieved. Future processing in the manufacturing system is simulated based on the workpiece fabrication data. At least one process parameter for the future processing is predicted based on the simulating. The workpiece is processed in at least one of the tools based on the predicted process parameter. A system includes a plurality of tools configured to process a workpiece and a simulation unit. The simulation unit is configured to retrieve workpiece fabrication data related to the processing, simulate future processing for the workpiece based on the workpiece fabrication data, and predict at least one process parameter for the future processing based on the simulating, wherein at least one of the tools is configured to process the workpiece based on the predicted process parameter.

### BACKGROUND OF THE INVENTION

1. FIELD OF THE INVENTION

This invention relates generally to the field of semiconductor device manufacturing and, more particularly, to a method and apparatus for providing first-principles feed-forward manufacturing control.

2. DESCRIPTION OF THE RELATED ART

There is a constant drive within the semiconductor industry to increase the quality, reliability and throughput of integrated circuit devices, e.g., microprocessors, memory devices, and the like. This drive is fueled by consumer demands for higher quality computers and electronic devices that operate more reliably. These demands have resulted in a continual improvement in the manufacture of semiconductor devices, e.g., transistors, as well as in the manufacture of integrated circuit devices incorporating such transistors. Additionally, reducing the defects in the manufacture of the components of a typical transistor also lowers the overall cost per transistor as well as the cost of integrated circuit devices incorporating such transistors.

Generally, a set of processing steps is performed on a wafer using a variety of processing tools, including photolithography steppers, etch tools, deposition tools, polishing tools, rapid thermal processing tools, implantation tools, etc. One technique for improving the operation of a semiconductor processing line includes using a factory wide control system to automatically control the operation of the various processing tools. The manufacturing tools communicate with a manufacturing framework or a network of processing modules. Each manufacturing tool is generally connected to an equipment interface. The equipment inter-face is connected to a machine interface which facilitates communications between the manufacturing tool and the manufacturing framework. The machine interface can generally be part of an advanced process control (APC) system. The APC system initiates a control script based upon a manufacturing model, which can be a software program that automatically retrieves the data needed to execute a manufacturing process. Often, semiconductor devices are staged through multiple manufacturing tools for multiple processes, generating data relating to the quality of the processed semiconductor devices. Pre-processing and/or post-processing metrology data is supplied to process controllers for the tools. Operating recipe parameters are calculated by the process controllers based on the performance model and the metrology information to attempt to achieve post-processing results as close to a target value as possible. Reducing variation in this manner leads to increased throughput, reduced cost, higher device performance, etc., all of which equate to increased profitability.

In a typical semiconductor fabrication facility, wafers are processed in groups, referred to as lots. The wafers in a particular lot generally experience the same processing environment. In some tools, all of the wafers in a lot are processed simultaneously, while in other tools the wafers are processed individually, but under similar conditions (e.g., using the same operating recipe). Typically, a lot of wafers is assigned a priority in the beginning of its processing cycle. Priority may be assigned on the basis of the number of wafers in the lot or its status as a test or experimental lot, for example.

During the fabrication process various events may take place that affect the performance of the devices being fabricated. That is, variations in the fabrication process steps result in device performance variations. Factors, such as feature critical dimensions, doping levels, contact resistance, particle contamination, etc., all may potentially affect the end performance of the device. Devices are typically ranked by a grade measurement, which effectively determines its market value. In general, the higher a device is graded, the more valuable the device.

Because of the large number of variables affecting a device's performance characteristics, it is difficult to predict the grade of the device prior to the performing of electrical tests on the devices. Wafer electrical test (WET) measurements are typically not performed on processed wafers until quite late in the fabrication process, sometimes not until weeks after the processing has been completed. When one or more of the processing steps produce resulting wafers that the WET measurements indicate are unacceptable, the resulting wafers may need to be scrapped. However, in the meantime, the misprocessing might have gone undetected and uncorrected for a significant time period, leading to many scrapped wafers, much wasted material, and decreased overall throughput. Also, certain combinations of in-spec processing in a number of steps could result in a product still being mis-targeted from an electrical or performance point of view. Given that consistent control for a large volume of wafers requires taking into account many process complexities, control of these processes typically requires a fully automated implementation.

In typical process control scenarios described above, empirical models are employed to predict and control the response of the controlled tool. In some cases, the prediction accuracy is decreased for a complex response where an empirical model does not accurately represent the interactions of the various factors in the system. For example, many factors contribute to the performance of a transistor. These factors include, for example, the thicknesses of process layers in the gate electrode stack, gate electrode critical dimension, implant dose and energy, and doped area dimensions. The nature of the interactions between these different factors in contributing to the performance of the transistor reduces the achievable accuracy of empirical models used to control the fabrication of the transistor.

The present invention is directed to overcoming, or at least reducing the effects of, one or more of the problems set forth above.

### SUMMARY OF THE INVENTION

One aspect of the present invention is seen in a method including processing a workpiece in a manufacturing system including a plurality of tools. Workpiece fabrication data related to the processing is retrieved. Future processing in the manufacturing system is simulated based on the workpiece fabrication data. At least one process parameter for the future processing is predicted based on the simulating. The workpiece is processed in at least one of the tools based on the predicted process parameter.

Another aspect of the present invention is seen in a system including a plurality of tools configured to process a workpiece and a simulation unit. The simulation unit is configured to retrieve workpiece fabrication data related to the processing, simulate future processing for the workpiece based on the workpiece fabrication data, and predict at least one process parameter for the future processing based on the simulating, wherein at least one of the tools is configured to process the workpiece based on the predicted process parameter.

### BRIEF DESCRIPTION OF THE DRAWINGS

The invention may be understood by reference to the following description taken in conjunction with the accompanying drawings, in which like reference numerals identify like elements, and in which:

FIG. 1 is a simplified block diagram of a manufacturing system in accordance with one illustrative embodiment of the present invention; and

FIG. 2 is a simplified flow diagram of a method for controlling a manufacturing process in accordance with another illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

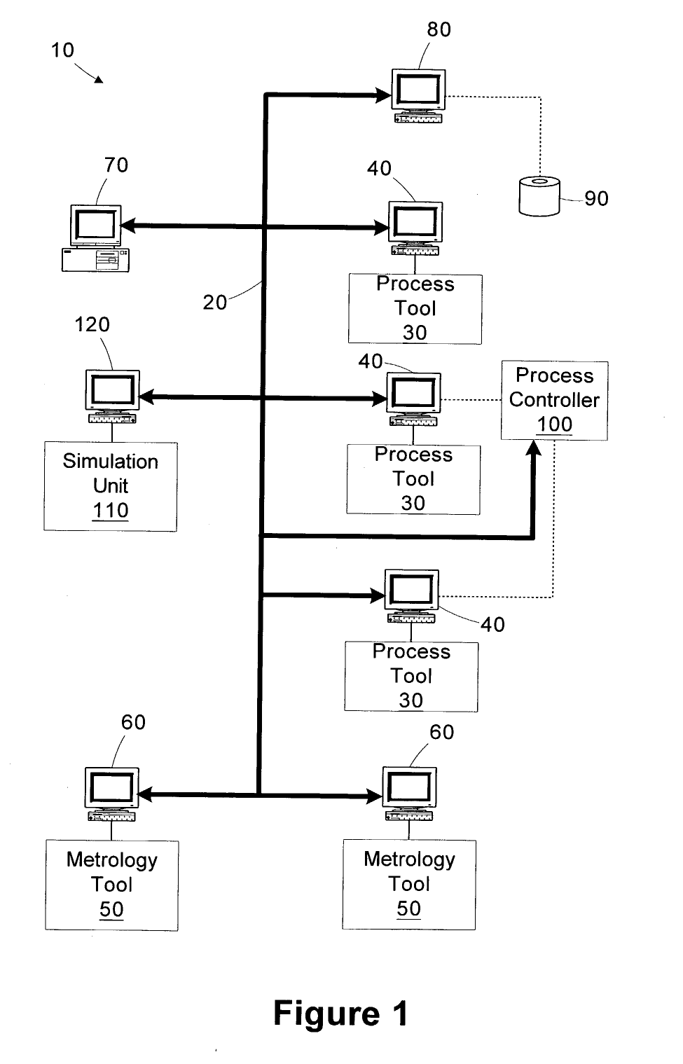

Referring to FIG. 1, a simplified block diagram of an illustrative manufacturing system 10 is provided. In the illustrated embodiment, the manufacturing system 10 is adapted to process semiconductor wafers, however, the invention is not so limited and may be applied to other types of manufacturing environments and other types of workpieces. A network 20 interconnects various components of the manufacturing system, allowing them to exchange information. The illustrative manufacturing system 10 includes a plurality of process tools 30, each being coupled to a computer 40 for interfacing with the network 20. The manufacturing system 10 also includes one or more metrology tools 50 coupled to computers 60 for interfacing with the network 20. The metrology tools 50 may be used to measure output characteristics of the wafers processed in the process tool 30 to generate metrology data. Although the tools 30, 50 are illustrated as interfacing with the network 20 through the computers 40, 60, the tools 30, 50 may include integrated circuitry for interfacing with the network 20, eliminating the need for the computers 40, 60. A manufacturing execution system (MES) server 70 directs the high level operation of the manufacturing system 10 by directing the flow of the manufacturing system 10. The MES server 70 monitors the status of the various entities in the manufacturing system, including the tools 30, 50. The process tools 30 may be process tools, such as photolithography steppers, etch tools, deposition tools, polishing tools, rapid thermal process tools, implantation tools, etc. The metrology tools 50 may be measurement tools, such as optical measurement tools, electrical measurement tools, scanning electron microscopes, gas analyzers, etc.

A database server 80 is provided for storing data related to the status of the various entities and workpieces (e.g., wafers). The database server 80 may store information in one or more data stores 90. The metrology data may include feature measurements, process layer thicknesses, electrical performance characteristics, defect measurements, surface profiles, etc. Maintenance history for the tools 30 (e.g., cleaning, consumable item replacement, repair) may also be stored in the data store 90 by the MES server 70 or by a tool operator.

Some of the process tools 30 interface with a process controller 100 that is adapted to automatically control the operating recipes of one or more of the tools. In the illustrated embodiment, the process controller 100 employs a first-principles (i.e, physics based) model for controlling the process tools.

The process controller 100 interfaces with a simulation unit 110 executing on a computer 120 for simulating manufacturing processes for the wafers. By simulating the manufacturing processes, the simulation unit 110 is capable of predicting electrical characteristics of the devices fabricated by the manufacturing system 10. The simulation unit 110 is also capable of providing data related to subsequent process steps to allow the completed devices to meet a predetermined electrical characteristic target. For example, if a target value is established for an electrical parameter, such as saturation current, IDₛₐₜ, the simulation unit 1 10 can predict manufacturing target values for the manufacturing system 10 to achieve the target saturation current. Typically, the simulation unit 110 simulates a series of process steps for the wafer being fabricated. In essence, the simulation unit 110 operates as a virtual fabrication facility. The user may specify that certain fabrication parameters be fixed, and that others may be variable. The simulation unit 110 manipulates the variable parameters during the simulation process to attempt to determine settings for the variable parameters that achieve the specified performance targets. In the example of transistor fabrication, parameters regarding gate insulation layer thickness and polysilicon thickness (i.e., the composition of the gate electrode stack) may be fixed, and parameters such as gate electrode width (i.e., controlled by gate etch parameters) and implant parameters (e.g., implant dose and energy for halo implant or other implants) may be specified as variable parameters. The simulation unit 110 then simulates the fabrication process and varies the one or more designated variable parameters to determine the parameter values that would most closely achieve the saturation current target. The results of the simulation may be in the form of targets for manufacturing processes (e.g., gate width of X nanometers) or operating recipe settings for the manufacturing processes (e.g., etch time of Y seconds or implant dose of Z dopant ions per unit volume).

The particular process operations simulated by the simulation unit 110 and the manufacturing parameters that are designated as being fixed or variable may vary depending on the particular embodiment. The target values for performance characteristics may also vary depending on the particular implementation.

An exemplary information exchange and process control framework suitable for use in the manufacturing system 10 is an Advanced Process Control (APC) framework, such as may be implemented using the Catalyst system offered by KLA-Tencor, Inc. The Catalyst system uses Semiconductor Equipment and Materials International (SEMI) Computer Integrated Manufacturing (CIM) Framework compliant system technologies and is based the Advanced Process Control (APC) Framework. CIM (SEMI E81-0699-Provisional Specification for CIM Framework Domain Architecture) and APC (SEMI E93-0999 -Provisional Specification for CIM Framework Advanced Process Control Component) specifications are publicly available from SEMI.

Portions of the invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices. The distribution of the processing and data storage functions amongst the different computers 40, 60, 70, 80, 120, is generally conducted to provide independence and a central information store. Of course, different numbers of computers and different arrangements may be used.

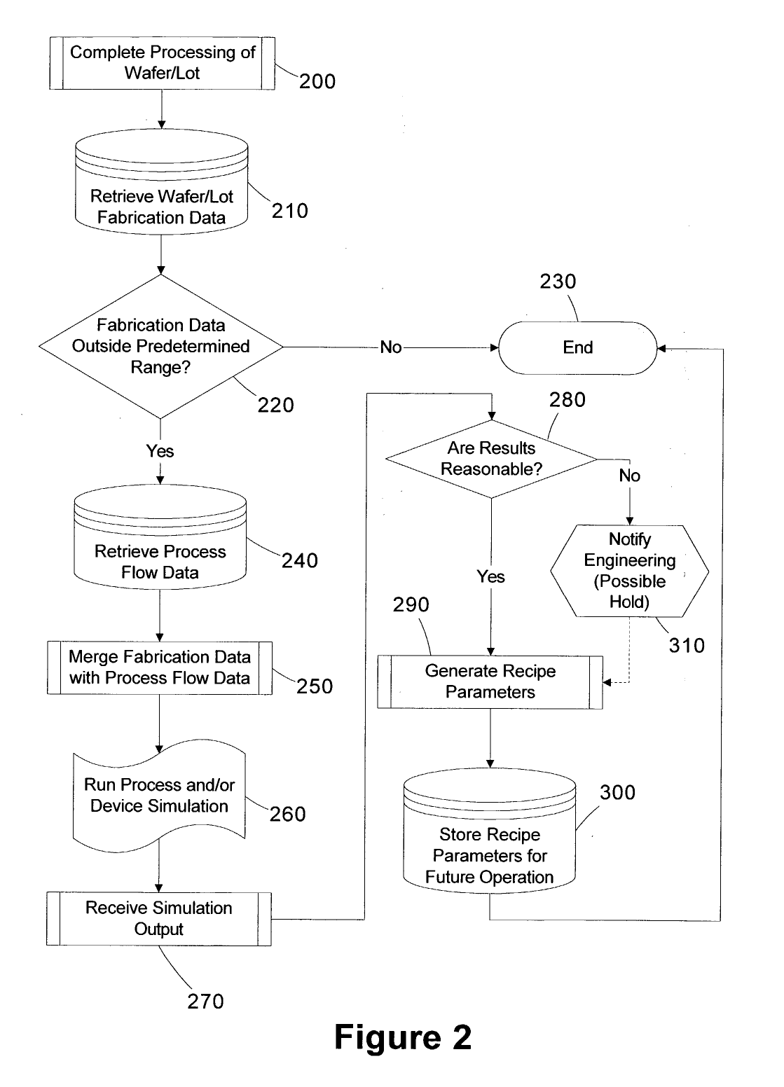

The operation of the process controller 100 and simulation unit 110 is further described in reference to FIG. 2, which depicts a simplified flow diagram of a method for controlling a manufacturing system in accordance with another embodiment of the present invention. In block 200, the processing of a wafer, or lot of wafers, by a process tool 30 is completed. In block 210, wafer/lot fabrication data is retrieved. The wafer/lot fabrication data may be stored in a variety of locations, such as, for example, the data stores 90 and/or the MES server 70. The process controller 100 may also store some of the wafer/lot fabrication data locally. The wafer/lot fabrication data includes information related to the previous processing performed on the wafer, such as metrology data collected regarding the characteristics of the wafer (e.g., process layer thickness). The wafer fabrication data may also include data collected by the process tool(s) 30, or from sensors (not shown) associated with the process tool(s) 30, regarding the processing environment experienced by the wafer during the fabrication process. Exemplary process data includes chamber pressure, chamber temperature, anneal time, implant dose, implant energy, plasma energy, processing time, etc. The wafer/lot fabrication data may also include data from the process controller 100 concerning the operating recipe settings used during the fabrication process. For example, it may not be possible to measure direct values for some process parameters. The process controller 100 may use the settings for these parameters in lieu of actual process data from the process tool 30. Other process control data may include the values of various state conditions estimated and/or controlled by the process controller 100.

In block 220, the fabrication data is compared to a predetermined threshold to determine if the data is within a predetermined range (i.e., or ranges for fabrication data relating to multiple parameters). For example, the thicknesses of the gate insulation layer and polysilicon layers may be compared to predetermined thresholds. This threshold differs from a typical fault detection and classification (FDC) type of analysis. FDC analysis typically looks for values that are outside established control limits indicating a potential fault condition. If a fault condition is identified rework may be required or the wafer/lot may be scrapped. Typically, a target value is provided (i.e., based on design requirements) for various parameters of the devices formed on the wafer. For example, a target value would be specified for the gate insulation and polysilicon layer thicknesses. If the fabrication data is near the target value, it is likely that the devices formed on the wafer will conform to design expectations. However, the fabrication data may be within an acceptable FDC range, but may be such that the performance of the devices may be reduced as compared to devices more closely meeting target values. This performance reduction equates to reduced revenue. The analysis conducted in box 220 identifies situations that are less than fault conditions, but may benefit from corrective measures aimed at mitigating the potential performance loss, thus preserving revenue. In one example, the process controller 100 may evaluate the metrology data collected regarding the wafer to determine if it is within predetermined limits. In another example, the process controller 100 may evaluate the tool and sensor data collected during previous processing activities performed on the wafer. If the process data indicates an abnormal processing environment (i.e., but less than a tool fault), the process controller 100 may initiate corrective actions.

In block 220, if the fabrication data is within a predetermined range, the process controller 100 takes no action and the process terminates in block 230. However, if the fabrication data is outside the predetermined range, the process controller 100 submits a simulation request to the simulation unit 110. Process flow data is retrieved by the process controller 100 or simulation unit 110 in block 240. The process flow data represents the default process settings and target values for the production process. The process flow data represents the production process with essentially no variation (i.e., all features are fabricated with dimensions equal to the target values). These parameters describe the experimental construct of a transistor (i.e., or other device being modeled) and are established based upon previous engineering knowledge.

In block 250, the fabrication data is merged with the process flow data. Actual metrology data and process data that is available for the wafer is substituted for the process flow data. Using the merged data, the simulation unit 110 simulates the processing of the wafer in block 260. Hence, the simulation unit 110 simulates the actual state of the wafer up to the current processing progress of the wafer.

The simulation unit 110 subsequently determines process targets and/or operating recipe settings for subsequent processing activities such that at some future time in the manufacturing process the wafer will have characteristics consistent with a predetermined performance target for the wafer. The simulation unit 110 may use the process flow data to fix certain process targets or settings for subsequent operations, while selecting other parameters that may be allowed to vary from their design values.

For example, if a particular saturation current performance target is desired for a transistor, the simulation unit 110 may fix values relating to the gate etch processes and allow variation on the halo implant parameters. In other embodiments, the simulation unit 110 may vary both the gate etch parameters and the halo implant parameters. Other parameters, such as source/drain implant parameters, lightly doped drain implant parameters, and spacer etch parameters may be fixed at their design values. By simulating the effects of changes on the variable parameters on the performance characteristic, the simulation unit 110 can determine process targets or settings that will be more likely to result in the achievement of the performance goal.

Various technology computer-aided design (TCAD) tools are commercially available for performing the functions of the simulation unit 110. Typically, the TCAD software is computationally intensive and executes on a stand-alone workstation. Requests are entered into a simulation queue and processed. The particular simulation tool selected depends on the type of semiconductor device being fabricated and the type of performance characteristics being controlled. Exemplary software tools are Tsuprem-4 and Medici offered by Synopsis, Inc. of Mountain View, Calif.. Various TCAD systems are also offered by Silvaco International of Santa Clara, Calif. and ISE Integrated Systems Engineering of Zurich, Switzerland. Exemplary performance target values that may be used for simulating process targets and/or settings are saturation current, drive current, ring oscillator frequency, memory cell erase times, contact resistance, effective channel length, etc.

The simulation results are received in block 270. The output of the simulation may vary depending on the particular type of simulation run (process or device), the fixed versus variable parameters, and the particular performance characteristic targeted. In the transistor example discussed herein, where saturation current is targeted, the simulation outputs may include implant parameters (i.e., energy, dose, and angle) for performing a halo implant or etch parameters for etching the gate electrodes. The width of a gate electrode may be controlled by various etch parameters. For example, during the gate etch, an increase in the etch time will result in a decrease in the width (i.e., overetch). The dimensions of the gate electrode may also be affected by performing a trim etch on the photoresist pattern used as a mask for the subsequent gate etch. An exemplary technique for performing a gate trim etch is described in greater detail in U.S. Pat. No. 6,110,785, entitled “FORMULATION OF HIGH PERFORMANCE TRANSISTORS USING GATE TRIM ETCH PROCESS,” and incorporated herein by reference in its entirety.

In block 280, the simulation results are analyzed to determine if the suggested process targets and/or settings are reasonable. For example, if a process tool cannot achieve a requested process setting, or the adjusted target is outside a predetermined range, it may not be possible to process the wafer during subsequent process steps as suggested by the simulation unit 110. For example, processing the wafer in the suggested manner may deleteriously affect other parameters not considered by the simulation unit 110. If the results are reasonable in block 280, recipe parameters for subsequent processing to be performed on the wafer are generated in block 290 and stored in block 300. For example, if the simulation output included a gate electrode critical dimension, the process controller 100 may calculate gate trim etch or gate etch parameters, such as etch time or plasma power, to achieve the target critical dimension. The process controller 100 may similarly calculate values for the halo implant parameters. Where the simulation output actually includes operating recipe parameters, the process controller 100 may not need to do further calculation. The process terminates in block 230.

If the simulation results were not acceptable in block 280, engineering personnel may be notified in block 310. Engineering may decide not to implement the suggested process target or process settings, to go ahead with the suggested changes, or to place the wafer or lot on hold pending a more detailed review to determine if rework is desirable.

The process described above allows feed-forward control to be implemented for the wafers being processed in situations other techniques, such as empirical modeling, would be unable to accurately consider the interactions between the various process variables. The feed-forward control allows the performance characteristics to be controlled, thus preserving the value of the fabricated devices. This enhanced control capability improves the profitability of the manufacturing system 10.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
processing a workpiece in a manufacturing system including a plurality of tools;
retrieving workpiece fabrication data related to the processing;
simulating future processing in the manufacturing system based on the workpiece fabrication data;
predicting at least one process parameter for the future processing based on the simulating; and
processing the workpiece in at least one of the tools based on the predicted process parameter.

2. The method of claim 1, wherein predicting the at least one process parameter for the future processing further comprises predicting a process target for the future processing.

3. The method of claim 1, wherein predicting the at least one process parameter for the future processing further comprises predicting an operating recipe parameter for the tool.

4. The method of claim 1, further comprising simulating completed processing in the manufacturing system based on the workpiece fabrication data

5. The method of claim 1, wherein simulating the further processing further comprises:
retrieving process flow data associated with the workpieces;
merging the workpiece fabrication data with the process flow data; and
simulating the future processing based on the merged data.

6. The method of claim 1, wherein receiving the workpiece fabrication data further comprises receiving metrology data associated with the workpiece.

7. The method of claim 1, wherein receiving the workpiece fabrication data further comprises receiving process data associated with the processing of the workpiece in at least one of the tools.

8. The method of claim 1, further comprising:
comparing the workpiece fabrication data to a predetermined range; and
simulating the future processing responsive to the workpiece fabrication data being outside the predetermined range.

9. The method of claim 1, further comprising:
comparing the predicted process parameter to a predetermined range; and
processing the workpiece based on the predicted process parameter responsive to the predicted process parameter being within the predetermined range.

10. The method of claim 1, further comprising:
comparing the predicted process parameter to a predetermined range; and
placing the workpiece on hold responsive to the predicted process parameter being outside the predetermined range.

11. The method of claim 1, wherein predicting the at least one process parameter further comprises predicting a process target for the processing.

12. The method of claim 11, further comprising determining an operating recipe parameter for the processing based on the process target.

13. The method of claim 1, wherein predicting the at least one process parameter further comprises predicting an operating recipe parameter for the processing.

14. A system, comprising:
a plurality of tools configured to process a workpiece; and
a simulation unit configured to retrieve workpiece fabrication data related to the processing, simulate future processing for the workpiece based on the workpiece fabrication data, and predict at least one process parameter for the future processing based on the simulating, wherein at least one of the tools is configured to process the workpiece based on the predicted process parameter.

15. The system of claim 14, wherein the simulation unit is further configured to predict a process target for the future processing.

16. The system of claim 14, wherein the simulation unit is further configured to predict an operating recipe parameter for the tool.

17. The system of claim 14, wherein the simulation unit is further configured to simulate completed processing in the manufacturing system based on the workpiece fabrication data

18. The system of claim 14, wherein the simulation unit is further configured to retrieve process flow data associated with the workpieces, merge the workpiece fabrication data with the process flow data, and simulate the future processing based on the merged data.

19. The system of claim 14, wherein the workpiece fabrication data further comprises metrology data associated with the workpiece.

20. The system of claim 14, wherein the workpiece fabrication data further comprises process data associated with the processing of the workpiece in at least one of the tools.

21. The system of claim 14, further comprising a process controller configured to compare the workpiece fabrication data to a predetermined range, and wherein the simulation unit is further configured to simulate the future processing responsive to the workpiece fabrication data being outside the predetermined range.

22. The system of claim 14, further comprising a process controller configured to compare the predicted process parameter to a predetermined range and direct the process tool to process the workpiece based on the predicted process parameter responsive to the predicted process parameter being within the predetermined range.

23. The system of claim 14, further comprising a process controller configured to compare the predicted process parameter to a predetermined range and place the workpiece on hold responsive to the predicted process parameter being outside the predetermined range.

24. The system of claim 14, wherein the at least one process parameter further comprises a process target for the processing.

25. The system of claim 24, further comprising a process controller configured to determine an operating recipe parameter for the processing based on the process target.

26. The system of claim 1, wherein the simulation unit is further configured to predict the at least one process parameter further comprises predicting an operating recipe parameter for the processing.

27. A system, comprising:
means for processing a workpiece;
means for retrieving workpiece fabrication data related to the processing;
means for simulating future processing based on the workpiece fabrication data;
means for predicting at least one process parameter for the future processing based on the simulating; and
means for processing the workpiece based on the predicted process parameter.
